(19) United States
(12) Patent Application Publication
(10) Pub. No.: US 2026/0264376 A1
(43) Pub. Date: Sep. 10, 2026

(54) HEAT-SHRINKABLE FILM

(71) Applicant: GUNZE LIMITED, Kyoto (JP)

(72) Inventors: Nobuhiro WATANABE, Shiga (JP); Jun TAKAICHI, Shiga (JP)

(21) Appl. No.: 19/167,513

(22) PCT Filed: Feb. 20, 2024
(86) PCT No.: PCT/JP2024/005991

§ 371 Date: Sep. 22, 2025

(30) Foreign Application Priority Data
Mar. 23, 2023 (JP) 2023-046317

(51) Int. Cl. B32B 27/08; B32B 27/30

(52) U.S. Cl. CPC B32B 27/08; B32B 27/302; B32B 2250/24; B32B 2307/54

(57) ABSTRACT

A heat-shrinkable film includes a first surface layer, a second surface layer, and an intermediate layer. The intermediate layer is formed between the first surface layer and the second surface layer. The intermediate layer contains a first high-impact polystyrene and a second high-impact polystyrene. The first high-impact polystyrene contains a general-purpose polystyrene and a first rubber component. The second high-impact polystyrene contains a styrene-butyl acrylate copolymer and a second rubber component. The first rubber component has a particle size that is larger than the particle size of the second rubber component. The blending ratio of the first high-impact polystyrene in the intermediate layer is greater than 0 wt % and less than 45.7 wt %.

### TECHNICAL FIELD

The present invention relates to a heat-shrinkable film.

### BACKGROUND ART

Japanese Patent No. 2972571 (Patent Document 1) discloses a heat-shrinkable film. This heat-shrinkable film has three layers, the intermediate layer of which is made of a high-impact polystyrene.

### CITATION LIST

### Patent Document

Patent Document 1: Japanese Patent No. 2972571

### SUMMARY OF INVENTION

### Technical Problem

The heat-shrinkable film disclosed in Patent Document 1 above is used, for example, as a label for covering a beverage container. The beverage container is stored at a low temperature while containing a beverage, for example. If the beverage container is dropped, for example, the label on the beverage container may be torn by the impact of the drop if the heat-shrinkable film has poor mechanical properties in a low-temperature environment.

The present invention has been made to solve such problems, and an object of the present invention is to provide a heat-shrinkable film having improved mechanical properties in a low-temperature environment.

### Solution to Problem

The heat-shrinkable film according to the present invention includes a first surface layer, a second surface layer, and an intermediate layer. The intermediate layer is formed between the first surface layer and the second surface layer. The intermediate layer includes a first high-impact polystyrene and a second high-impact polystyrene. The first high-impact polystyrene contains a general-purpose polystyrene and a first rubber component. The second high-impact polystyrene contains a styrene-butyl acrylate copolymer and a second rubber component. The first rubber component has a particle size that is larger than the particle size of the second rubber component. A blending ratio of the first high-impact polystyrene in the intermediate layer is greater than 0 wt % and less than 45.7 wt %.

The inventor(s) of the present invention have discovered that the mechanical properties of a heat-shrinkable film in a low-temperature environment are improved by incorporating two types of high-impact polystyrene having mutually different rubber component particle sizes into the intermediate layer of the heat-shrinkable film, and by setting the blending ratio of the high-impact polystyrene containing the rubber component with the larger particle size in the intermediate layer to be greater than 0 wt % and less than 45.7 wt %. In the heat-shrinkable film according to the present invention, the intermediate layer contains first and second high-impact polystyrenes, the first rubber component contained in the first high-impact polystyrene has a particle size that is larger than the particle size of the second rubber component contained in the second high-impact polystyrene, and the blending ratio of the first high-impact polystyrene in the intermediate layer is greater than 0 wt % and less than 45.7 wt %. With this heat-shrinkable film, it is possible to improve the mechanical properties of the heat-shrinkable film in a low-temperature environment.

In the above-described heat-shrinkable film, the first rubber component may have a particle size of 1 μm or more and 3 μm or less, and the second rubber component may have a particle size of less than 1 μm.

In the above-described heat-shrinkable film, the blending ratio of the first high-impact polystyrene in the intermediate layer may be 4.6 wt % or more and 36.6 wt % or less.

The inventor(s) discovered that in the above-described heat-shrinkable film, the mechanical properties of the heat-shrinkable film in a low-temperature environment can be further improved by setting the blending ratio of the first high-impact polystyrene in the intermediate layer to 4.6 wt % or more and 36.6 wt % or less. In the heat-shrinkable film according to the present invention, the blending ratio of the first high-impact polystyrene in the intermediate layer is 4.6 wt % or more and 36.6 wt % or less. With this heat-shrinkable film, it is possible to further improve the mechanical properties of the heat-shrinkable film in a low-temperature environment.

In the above-described heat-shrinkable film, the intermediate layer may further contain a styrene-butadiene copolymer.

According to this heat-shrinkable film, the intermediate layer further contains a styrene-butadiene copolymer, which improves the compatibility of the polymer alloy that constitutes the intermediate layer, thereby further improving the mechanical properties of the heat-shrinkable film in a low-temperature environment.

The above-described heat-shrinkable film may have a tensile breaking strength in an MD (Machine Direction) measured in conformity with JIS K-6732 in a 5° C. environment of 35 MPa or more and 43 MPa or less.

This heat-shrinkable film has a sufficiently high tensile breaking strength in a 5° C. environment, and therefore it is possible to sufficiently improve the mechanical properties of the heat-shrinkable film in a low-temperature environment.

### Advantageous Effects of the Invention

According to the present invention, it is possible to provide a heat-shrinkable film having improved mechanical properties in a low-temperature environment.

### BRIEF DESCRIPTION OF DRAWINGS

FIG. 1 is a diagram schematically showing a cross-section of a heat-shrinkable film.

FIG. 2 is a diagram showing a schematic configuration of a manufacturing apparatus for the heat-shrinkable film.

### DESCRIPTION OF EMBODIMENTS

An embodiment according to one aspect of the present invention (hereinafter also referred to as “the present embodiment”) will be described in detail below with reference to the drawings. In addition, the same or corresponding parts in the drawings are denoted by the same reference signs and description thereof will not be repeated. In addition, for ease of understanding, each drawing is drawn schematically with objects omitted or exaggerated as appropriate.

### 1. Configuration of Heat-Shrinkable Film

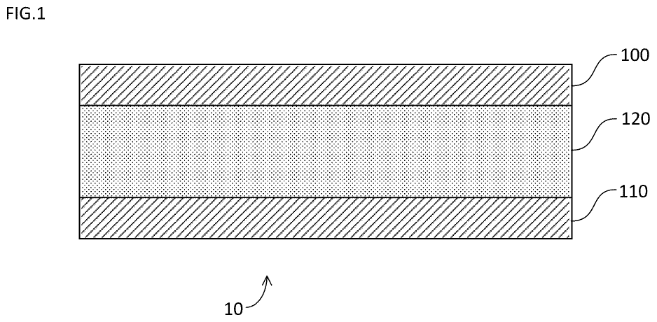

FIG. 1 is a diagram schematically showing a cross-section of a heat-shrinkable film 10 according to the present embodiment. With reference to FIG. 1, the heat-shrinkable film 10 is used as a base material for a heat-shrinkable label for covering, for example, a plastic beverage container or the like. When a beverage is stored in a refrigerator or the like, the heat-shrinkable label covering the beverage container or the like is placed in an environment of, for example, 2° C. or higher and 5° C. or lower. The heat-shrinkable film 10 is designed to have improved mechanical properties in a low-temperature environment, such as 2° C. or higher and 5° C. or lower. The heat-shrinkable film 10 will be described in detail below. Note that the thickness of the heat-shrinkable film 10 is, for example, 10 μm or more and 60 μm or less, preferably 15 μm or more and 35 μm or less, more preferably 20 μm or more and 30 μm or less, and even more preferably 20 μm or more and 25 μm or less.

The heat-shrinkable film 10 includes, for example, a first surface layer 100, a second surface layer 110, and an intermediate layer 120. One of the first surface layer 100 and the second surface layer 110 is formed on one surface of the heat-shrinkable film 10, and the other of the first surface layer 100 and the second surface layer 110 is formed on the other surface of the heat-shrinkable film 10. The intermediate layer 120 is formed between the first surface layer 100 and the second surface layer 110 in the thickness direction of the heat-shrinkable film 10. The ratio of the thickness of each of the first surface layer 100 and the second surface layer 110 to the thickness of the intermediate layer 120 (thickness of each of the first surface layer 100 and the second surface layer 110:thickness of the intermediate layer 120) is 1:1 to 1:15, preferably 1:2 to 1:10, and more preferably 1:3 to 1:8. The thicknesses of the first surface layer 100 and the second surface layer 110 do not need to be the same, but are preferably the same.

The first surface layer 100 and the second surface layer 110 each contain a resin. Examples of resins contained in the first surface layer 100 and the second surface layer 110 include polystyrene-based resins and hydrogenated products thereof, and polyester-based resins. As a polystyrene-based resin, a styrene-butadiene copolymer (SBS) is preferred, and as a polyester-based resin, an amorphous polyester copolymer is preferred. The first surface layer 100 and the second surface layer 110 do not necessarily need to contain the same resin, and may contain mutually different resins.

The intermediate layer 120 includes two types of high-impact polystyrene (HIPS), for example, a first high-impact polystyrene (hereinafter also referred to as “first HIPS”) and a second high-impact polystyrene (hereinafter also referred to as “second HIPS”).

The first HIPS contains, for example, a general-purpose polystyrene (GPPS) and a first rubber component. The general-purpose polystyrene is, for example, a homopolymer of styrene. An example of the first rubber component is butadiene-based rubber particles (e.g., a styrene-butadiene copolymer). The first rubber component has a particle size of, for example, 1 μm or more and 3 μm or less. The first HIPS is constituted by, for example, a sea-island alloy in which butadiene-based rubber particles are dispersed in a matrix constituted by the general-purpose polystyrene.

The second HIPS contains, for example, a styrene-butyl acrylate copolymer and a second rubber component. An example of the second rubber component is a styrene-1,3-butadiene copolymer grafted with a styrene-butyl acrylate copolymer. The second rubber component has a particle size of, for example, less than 1 μm. That is, the first rubber component has a particle size that is larger than the particle size of the second rubber component. The second HIPS is constituted by, for example, a sea-island alloy in which a buta-1,3-diene-butyl acrylate-styrene polymer (a styrene-1,3-butadiene copolymer grafted with a styrene-butyl acrylate copolymer) is dispersed in a matrix constituted by a styrene-butyl acrylate copolymer.

The blending ratio of the first HIPS in the intermediate layer 120 is, for example, greater than 0 wt % and less than 45.7 wt %, and preferably 4.6 wt % or more and 36.6 wt % or less. The blending ratio of the second HIPS in the intermediate layer 120 is, for example, greater than 45.7 wt % and less than 100 wt %, and is preferably 54.8 wt % or more and 86.8 wt % or less.

The intermediate layer 120 may further contain a styrene-butadiene copolymer (SBS). The blending ratio of the SBS in the intermediate layer 120 may be, for example, 5 wt % or more and 20 wt % or less. Also, if the surface layers contain the SBS, the SBS contained in the intermediate layer 120 is preferably the same as the SBS contained in the surface layers, but may be different from the SBS contained in the surface layers. In addition, if the surface layers contain the SBS, the SBS contained in the intermediate layer 120 may be made from recycled material derived from the surface layers.

Note that the resin contained in the first surface layer 100, the second surface layer 110, and the intermediate layer 120 does not necessarily need to be a petroleum-derived resin, but may be, for example, a biomass-derived resin or a recycled material-derived resin. The recycled resin may be a resin derived from chemical recycling or a resin derived from material recycling.

As mentioned above, the heat-shrinkable film 10 is used, for example, in a label for covering a beverage container. The beverage container is stored at a low temperature while containing a beverage, for example. If the beverage container is dropped, for example, the label on the beverage container may be torn by the impact of the drop if the heat-shrinkable film has poor mechanical properties in a low-temperature environment.

The inventor(s) discovered that the mechanical properties of the heat-shrinkable film 10 in a low-temperature environment can be improved by incorporating two types of HIPS with different rubber component particle sizes into the intermediate layer 120 of the heat-shrinkable film 10, and by setting the blending ratio of the high-impact polystyrene (first HIPS) containing the rubber component with the larger particle size in the intermediate layer 120 to greater than 0 wt % and less than 45.7 wt %. In the heat-shrinkable film 10 according to this embodiment, the intermediate layer 120 contains the first and second HIPSs, the first rubber component contained in the first HIPS has a particle size that is larger than the particle size of the second rubber component contained in the second HIPS, and the blending ratio of the first HIPS in the intermediate layer 120 is greater than 0 wt % and less than 45.7 wt %. With the heat-shrinkable film 10, it is possible to improve the mechanical properties of the heat-shrinkable film in a low-temperature environment.

Furthermore, the inventor(s) discovered that the mechanical properties of the heat-shrinkable film 10 in a low-temperature environment can be further improved by setting the blending ratio of the first HIPS in the intermediate layer 120 to 4.6 wt % or more and 36.6 wt % or less. As described above, in the heat-shrinkable film 10, the blending ratio of the first high-impact polystyrene in the intermediate layer 120 may be 4.6 wt % or more and 36.6 wt % or less. With this heat-shrinkable film 10, the mechanical properties of the heat-shrinkable film in a low-temperature environment can be further improved.

As described above, in the heat-shrinkable film 10, the intermediate layer 120 may further contain a styrene-butadiene copolymer. With this heat-shrinkable film 10, the intermediate layer 120 further contains a styrene-butadiene copolymer, which improves the compatibility of the polymer alloy that constitutes the intermediate layer 120, thereby making it possible to further improve the mechanical properties of the heat-shrinkable film in a low-temperature environment.

In addition, the heat-shrinkable film 10 may have a tensile breaking strength in the MD (Machine Direction) measured in a 5° C. environment in conformity with JIS K-6732 of 35 MPa or more and 43 MPa or less. This heat-shrinkable film 10 has a sufficiently high tensile breaking strength in a 5° C. environment, and therefore it is possible to sufficiently improve the mechanical properties of the heat-shrinkable film in a low-temperature environment.

### 2. Method for Manufacturing Heat-Shrinkable Film

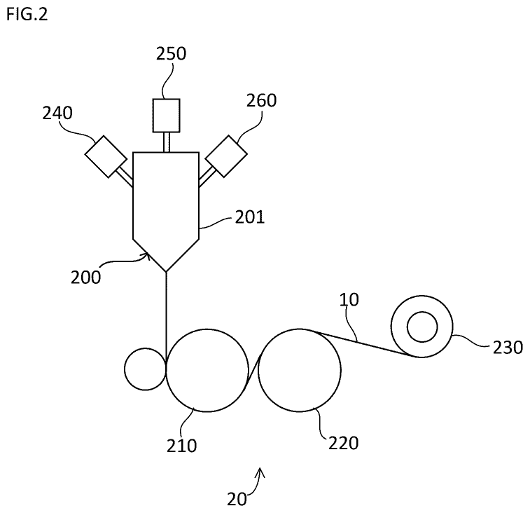

FIG. 2 is a diagram schematically showing the configuration of a manufacturing apparatus 20 for the heat-shrinkable film 10 according to the present embodiment. The heat-shrinkable film 10 is manufactured by the manufacturing apparatus 20. As shown in FIG. 2, the manufacturing apparatus 20 includes a T-die 200, casting rolls 210 and 220, and a take-up roll 230.

The T-die 200 includes a T-die body 201 and raw material input portions 240, 250, and 260. The raw material for forming the first surface layer 100 is input into the raw material input portion 240, and the raw material for forming the second surface layer 110 is input into the raw material input portion 260. For example, a styrene-butadiene copolymer (SBS) is input into the raw material input portions 240 and 260. For example, at least a portion of an antiblocking agent, an antistatic agent, and an antioxidant may be further input into the raw material input portions 240 and 260.

The raw material for forming the intermediate layer 120 is input into the raw material input portion 250. For example, the first HIPS and the second HIPS are input into the raw material input portion 250. For example, at least one of an antioxidant and an elastomer resin may be further input into the raw material input portion 250.

The T-die body 201 is configured to co-extrude the raw materials input via the raw material input portions 240, 250, and 260, whereby the molten raw materials input into the raw material input portions are fused to form a single integrated film (molten material). The casting rolls 210 and 220 are configured to cool the extruded molten material and send it downstream. The take-up roll 230 is configured to draw and take up the molten material cooled by the casting rolls 210 and 220 at a predetermined speed. A roll of the heat-shrinkable film 10 is manufactured through the manufacturing process in the manufacturing apparatus 20.

### 3. Characteristics

As described above, in the heat-shrinkable film 10 according to this embodiment, the intermediate layer 120 contains first and second high-impact polystyrenes (HIPSs), a first rubber component contained in the first high-impact polystyrene has a particle size that is larger than the particle size of the second rubber component contained in the second high-impact polystyrene, and the blending ratio of the first high-impact polystyrene in the intermediate layer 120 is greater than 0 wt % and less than 45.7 wt %. With the heat-shrinkable film 10, it is possible to improve the mechanical properties of the heat-shrinkable film in a low temperature environment.

### 4. Other Embodiments

The concept of the above embodiment is not limited to the embodiment described above. Examples of other embodiments to which the concept of the above embodiment can be applied will be described below.

<4-1>

In the above-described embodiment, the heat-shrinkable film 10 includes only three layers. However, the heat-shrinkable film 10 does not necessarily need to be constituted by only three layers, and may include other layers such as an adhesive layer that adheres the layers together.

<4-2>

The heat-shrinkable film 10 according to the above-described embodiment does not necessarily need to be used as a base material for a heat-shrinkable label for covering a beverage container, but may also be used as a base material for a heat-shrinkable label for covering, for example, a container other than a beverage container that is to be placed in a low-temperature environment.

<4-3>

In the above-described embodiment, the first rubber component does not necessarily need to have a particle size of 1 μm or more and 3 μm or less, and the second rubber component does not necessarily need to have a particle size of less than 1 μm. It is sufficient that the first rubber component has a particle size that is larger than the particle size of the second rubber component.

The embodiments of the present invention have been described above by way of example. That is, the detailed description and accompanying drawings have been disclosed for the purpose of illustrative description. Accordingly, some of the elements described in the detailed description and the accompanying drawings may not be essential for solving the problem. Accordingly, these non-essential elements should not be immediately identified as essential just because these non-essential elements are described in the detailed description and accompanying drawings.

In addition, the above-described embodiments are merely examples of the present invention in all respects. The above-described embodiments can be improved or modified in various ways within the scope of the present invention. That is, in implementing the present invention, specific configurations can be adopted as appropriate depending on the embodiment.

### EXAMPLES

Examples of the present invention will be described below. Note that the present invention is not limited to the following examples.

### 1. Examples and Comparative Examples

Heat-shrinkable films of Examples 1 to 9 and Comparative Examples 1 to 4 were produced using the following method. Raw material compositions constituting each layer were fed into an extruder with a barrel temperature of 160 to 200° C., extruded through a multi-layer die at 200° C. into the form of a three-layer sheet, and cooled and solidified on a take-up roll at 50° C. Each of the films was then stretched at a stretch ratio of 3.5 in a tenter stretching machine with a preheating zone of 102° C., a stretching zone of 89 to 91° C., and a thermosetting zone of 86° C., and then was wound using a take-up machine to manufacture a heat-shrinkable film in which the direction perpendicular to the main shrinkage direction is MD and the main shrinkage direction is TD.

In each of Examples 1 to 9 and Comparative Examples 1 to 4, the first surface layer and the second surface layer were made of a styrene-butadiene copolymer (SBS). In each of the first surface layer and the second surface layer of each of Examples 1 to 9 and Comparative Examples 1 to 4, the weight percent concentration of the SBS was 100 wt %. In each of Examples 1 to 9 and Comparative Examples 1 to 4, the total thickness of the heat-shrinkable film was 30 μm, and the thickness of the first surface layer, the thickness of the intermediate layer, and thickness of the second surface layer were in a ratio of 1:8:1.

In each of the heat-shrinkable films of Examples 1 to 3, 5, and 7 to 9, the intermediate layer contained the first HIPS, the second HIPS, and the SBS. The weight percent concentration of the SBS in the intermediate layer of each heat-shrinkable film was 8.6 wt %. In each heat-shrinkable film, the blending ratio of the first HIPS and the second HIPS in the intermediate layer was different. The weight percent concentrations of the intermediate layers of Examples 1 to 3, 5, and 7 to 9 were 4.6 wt %, 9.1 wt %, 13.7 wt %, 18.3 wt %, 22.8 wt %, 27.4 wt %, and 36.6 wt %, respectively. The weight percent concentrations of the second HIPS in the intermediate layers of Examples 1 to 3, 5, and 7 to 9 were 86.2 wt %, 82.3 wt %, 77.7 wt %, 73.1 wt %, 68.6 wt %, 64.0 wt %, and 54.8 wt %, respectively.

In each of the heat-shrinkable films of Examples 4 and 6, the intermediate layer contained the first HIPS and the second HIPS. In each of the heat-shrinkable films of Examples 4 and 6, the intermediate layer did not contain the SBS. In the intermediate layers of Examples 4 and 6, the weight percent concentrations of the first HIPS were 13.7 wt % and 18.7 wt %, respectively, and the weight percent concentrations of the second HIPS were 86.3 wt % and 81.3 wt %, respectively. The blending ratio of the raw materials in each layer of each of the heat-shrinkable films of Examples 1 to 9 was as shown in Table 1 below.

TABLE 1

| Layer | Raw material | Example 1 | | Example 2 | | Example 3 | | Example 4 | | Example 5 | |
|---|---|---|---|---|---|---|---|---|---|---|---|
| First surface layer | SBS | 100 | wt % | 100 | wt % | 100 | wt % | 100 | wt % | 100 | wt % |
| Intermediate layer | First HIPS | 4.6 | wt % | 9.1 | wt % | 13.7 | wt % | 13.7 | wt % | 18.3 | wt % |
| | Second HIPS | 86.8 | wt % | 82.3 | wt % | 77.7 | wt % | 86.3 | wt % | 73.1 | wt % |
| | SBS | 8.6 | wt % | 8.6 | wt % | 8.6 | wt % | 0 | wt % | 8.6 | wt % |
| Second surface layer | SBS | 100 | wt % | 100 | wt % | 100 | wt % | 100 | wt % | 100 | wt % |

| Layer | Raw material | Example 6 | | Example 7 | | Example 8 | | Example 9 | |
|---|---|---|---|---|---|---|---|---|---|
| First surface layer | SBS | 100 | wt % | 100 | wt % | 100 | wt % | 100 | wt % |
| Intermediate layer | First HIPS | 18.7 | wt % | 22.8 | wt % | 27.4 | wt % | 36.6 | wt % |
| | Second HIPS | 81.3 | wt % | 68.6 | wt % | 64.0 | wt % | 54.8 | wt % |
| | SBS | 0 | wt % | 8.6 | wt % | 8.6 | wt % | 8.6 | wt % |
| Second surface layer | SBS | 100 | wt % | 100 | wt % | 100 | wt % | 100 | wt % |

In each of the heat-shrinkable films of Comparative Examples 1 and 2, the intermediate layer contained the first HIPS, the second HIPS, and the SBS. The weight percent concentration of SBS in the intermediate layer of each heat-shrinkable film was 8.6 wt %. In each heat-shrinkable film, the blending ratio of the first HIPS and the second HIPS in the intermediate layer was different. The weight percent concentrations of the first HIPS in the intermediate layers of Comparative Examples 1 and 2 were 45.7 wt % and 64.0 wt %, respectively. The weight percent concentrations of the second HIPS in the intermediate layers of Comparative Examples 1 and 2 were 45.7 wt % and 27.4 wt %, respectively.

In the heat-shrinkable film of Comparative Example 3, the intermediate layer contained the second HIPS and the SBS. In the intermediate layer of the heat-shrinkable film of Comparative Example 3, the weight percent concentration of the second HIPS was 91.4 wt %, and the weight percent concentration of the SBS was 8.6 wt %.

In the heat-shrinkable film of Comparative Example 4, the intermediate layer contained the second HIPS. The weight percent concentration of the second HIPS in the intermediate layer was 100 wt %. The blending ratio of raw materials in each layer of each heat-shrinkable film of Comparative Examples 1 to 4 was as shown in Table 2 below.

TABLE 2

| | | Com- | Com- | Com- | Com- |
|---|---|---|---|---|---|
| | Raw | parative | parative | parative | parative |
| Layer | material | Example 1 | Example 2 | Example 3 | Example 4 |
| First surface | SBS | 100 wt % | 100 wt % | 100 wt % | 100 wt % |
| layer | | | | | |
| Intermediate | First | 45.7 wt % | 64.0 wt % | 0 wt % | 0 wt % |
| layer | HIPS | | | | |
| | Second | 45.7 wt % | 27.4 wt % | 91.4 wt % | 100 wt % |
| | HIPS | | | | |
| | SBS | 8.6 wt % | 8.6 wt % | 8.6 wt % | 0 wt % |
| Second | SBS | 100 wt % | 100 wt % | 100 wt % | 100 wt % |
| surface layer | | | | | |

Note that in each of the heat-shrinkable films of Examples 1 to 9 and Comparative Examples 1 and 2, the first HIPS was constituted by a sea-island alloy in which a styrene-butadiene copolymer (first rubber component) was dispersed in a matrix constituted by a general-purpose polystyrene. The first rubber component had a particle size of 1 μm or more and 3 μm or less. In addition, in each of the heat-shrinkable films of Examples 1 to 9 and Comparative Examples 1 to 4, the second HIPS was constituted by a sea-island alloy in which a buta-1,3-diene-butyl acrylate-styrene polymer (second rubber component) was dispersed in a matrix constituted by a styrene-butyl acrylate copolymer. The second rubber component had a particle size of less than 1 μm.

### 2. Various Measurements

### <2-1. Tensile Breaking Strength>

A measurement sample having dimensions of 40 mm in a longitudinal direction×10 mm in the transverse direction (with the MD of the film defined as the longitudinal direction and the TD (Transverse Direction) as the transverse direction) was cut out from any position of each of the heat-shrinkable films of Examples 1 to 9 and Comparative Examples 1 to 4. The measurement samples were set in a Strograph (VE-1D, manufactured by Toyo Seiki Seisakusho, Ltd.), and the tensile breaking strengths (MPa) were measured in conformity with JIS K-6732.

### <2-2. Tensile Breaking Elongation>

A measurement sample having dimensions of 40 mm in the longitudinal direction×10 mm in the transverse direction was cut out from any position of each of the heat-shrinkable films of Examples 1 to 9 and Comparative Examples 1 to 4. The measurement samples were set in a Strograph (VE-1D, manufactured by Toyo Seiki Seisaku-sho, Ltd.), and the elongation (%) at tensile breakage was measured in conformity with JIS K-6732.

### <2-3. Tensile Breaking Strength at 5° C.>

A measurement sample having dimensions of 40 mm in the longitudinal direction×10 mm in the transverse direction was cut out from any position of each of the heat-shrinkable films of Examples 1 to 9 and Comparative Examples 1 to 4. The measurement samples were set in a Strograph (VE-1D, manufactured by Toyo Seiki Seisaku-sho, Ltd.), and the tensile breaking strengths (MPa) were measured in conformity with JIS K-6732. The temperature during the measurement was 5° C. and the tensile speed was 100 mm/min.

### <2-4. Tensile Breaking Elongation at 5° C.>

A measurement sample having dimensions of 40 mm in the longitudinal direction×10 mm in the transverse direction was cut out from any position of each of the heat-shrinkable films of Examples 1 to 9 and Comparative Examples 1 to 4. The measurement samples were set in a Strograph (VE-1D, manufactured by Toyo Seiki Seisaku-sho, Ltd.), and the elongation (%) at tensile breakage was measured in conformity with JIS K-6732. The temperature during the measurement was 5° C. and the tensile speed was 100 mm/min.

### <2-5. Elongation Breakage Count at 5° C.>

A measurement sample having dimensions of 40 mm in the longitudinal direction×10 mm in the transverse direction was cut out from any position of each of the heat-shrinkable films of Examples 1 to 9 and Comparative Examples 1 to 4. The measurement samples were set in a Strograph (VE-1D, manufactured by Toyo Seiki Seisaku-sho, Ltd.), and the tensile breaking elongation was measured in conformity with JIS K-6732. The temperature during the measurement was 5° C. and the tensile speed was 100 mm/min. The evaluation of tensile breaking elongation (toughness) was conducted by determining whether breakage occurred at 100% or more, which was evaluated as “acceptable”, or at less than 100%, which was evaluated as “unacceptable”, and the number of unacceptable results was counted for N=4 samples.

### <2-6. Impact Puncture Strength>

Each of the heat-shrinkable films of Examples 1 to 9 and Comparative Examples 1 to 4 was cut into a sample having dimensions of 100 mm in the longitudinal direction×100 mm in the transverse direction to obtain a test piece. The impact puncture strength of the obtained test piece was measured using a film impact tester manufactured by Toyo Seiki Seisaku-sho, Ltd. according to a method in conformity with JIS P 8134. Specifically, the test piece was fixed on a platform. Next, a hook fixing an arm of the film impact tester was removed, causing the fan-shaped arm to rotate around its axis, and an impact head attached to a distal end of the arm punctured the test piece. The energy required for the impact head to puncture the test piece was quantified as the impact strength. The impact strength was measured five times and the average value was calculated.

### <2-7. Young's Modulus>

Each of the heat-shrinkable films of Examples 1 to 9 and Comparative Examples 1 to 4 was cut into a sample having dimensions of 250 mm in the longitudinal direction×5 mm in the transverse direction to obtain a test piece. The Young's modulus of the obtained test piece was measured using a Strograph VE-1D manufactured by Toyo Seiki Seisakusho Co., Ltd. according to a method in conformity with ASTM D882. Note that for each example and comparative example, the Young's modulus was measured using four test pieces and the average value thereof was calculated.

### <2-8. Compressive Strength>

The compressive strength of each of the heat-shrinkable films of Examples 1 to 9 and Comparative Examples 1 to 4 was measured using a method in conformity with JIS P8126. Specifically, the following method was used. Each heat-shrinkable film of Examples 1 to 5 and Comparative Examples 1 to 3 was cut into a strip that was 152.4 mm long and 12.7 mm wide, and set in a cylindrical shape on a support produced in advance. The support was then placed on a stand of a ring crush tester (Model D, manufactured by Toyo Seiki Seisakusho, Ltd.) to measure the compressive strength. Measurement was performed for only the compressive strength in the longitudinal direction (the direction of film flow) on n=8 test pieces, and the average value thereof was calculated.

### <2-9. Heat Shrinkage Rate>

Each of the heat-shrinkable films of Examples 1 to 9 and Comparative Examples 1 to 4 was cut into a sample having dimensions of 100 mm in the longitudinal direction×100 mm in the transverse direction to obtain a test piece. The obtained test pieces were immersed in warm water at 70° C., 80° C., and 90° C. and boiling water (98° C.) for 10 seconds, then removed and immersed in water at 15° C. for 5 seconds. The MD heat shrinkage rate was calculated according to the following Formula (1), and the TD heat shrinkage rate was calculated according to the following Formula (2). Note that in the following Formula (1), LMD is the MD length of the test piece after heat shrinkage, and LTD in the following Formula (2) is the TD length of the test piece after heat shrinkage. Note that for the heat-shrinkable film of each example and comparative example, the heat shrinkage rate was measured using three test pieces and the average value was used.

$$Heat shrinkage rate ( \% ) = \{ ( 100 - LMD ) / 100 \} \times 100 \qquad ( 1 )$$

$$Heat shrinkage rate ( \% ) = \{ ( 100 - LTD ) / 100 \} \times 100 \qquad ( 2 )$$

### <2-10. Natural Shrinkage Rate>

Each of the heat-shrinkable films of Examples 1 to 9 and Comparative Examples 1 to 4 was cut into a size of 100 mm in the longitudinal direction×100 mm in the transverse direction, and left to stand in a low-temperature incubator (IL-82, manufactured by Yamato Scientific Co., Ltd.) adjusted to 30° C. and 40° C. for 7 days, and the natural shrinkage rate was measured based on Formulas (1) and (2) described in the “Heat Shrinkage Rate” section.

### <2-11. Haze>

Measurement samples measuring 50 mm×100 mm were cut out from any location of each of the heat-shrinkable films of Examples 1 to 9 and Comparative Examples 1 to 4. These were used as test pieces and the haze of each film was measured in conformity with JIS K 7136. For each example and comparative example, six test pieces were used for measurement and the average value was calculated. The haze was measured using a haze meter NDH8000 (manufactured by Nippon Denshoku Industries Co., Ltd.). A haze of 10% or less was considered favorable. If the haze exceeds 10%, the film becomes whitish and cloudy.

### <2-12. Mirror-Surface Gloss>

For each of the heat-shrinkable films of Examples 1 to 9 and Comparative Examples 1 to 4, gloss was measured at an incident angle of 45° using a VG-2000 model manufactured by Nippon Denshoku Industries Co., Ltd. using a method in conformity with JIS Z8741.

### <2-13. Particle Size of Rubber Component>

The particle size of each rubber component used in each heat-shrinkable film of Examples 1 to 9 and Comparative Examples 1 to 4 was measured using the following method. Test pieces were cut into 300 μm² pieces, embedded in resin (Nissin EM Quetol-812 (base), Nissin EM DDSA (hardener), and Nissin EM DMP-30 (accelerator) at a ratio of 7.6:10.0:0.27, 60° C., 15 hours), and then hardened. Ultra-thin sections of 1000 nm were created from the hardened test pieces using a microtome. The created ultra-thin sections were coated with an osmium coater (Neoc-STB, Meiwafosis Co., Ltd.), and images were taken using a STEM (Hitachi S-4800, Hitachi, Ltd.) at an accelerating voltage of 30 kV and a magnification of 10 k or 30 k, and the particle size was measured.

### 3. Measurement Results

The result of each measurement is shown in Tables 3 and 4 below.

TABLE 3

| | | | | Ex. 1 | | Ex. 2 | | Ex. 3 | | Ex. 4 | | Ex. 5 | |
|---|---|---|---|---|---|---|---|---|---|---|---|---|---|
| Measurement item | Units | Measurement condition | | MD | TD | MD | TD | MD | TD | MD | TD | MD | TD |
| Tensile breaking strength | MPa | — | | 40 | 77 | 36 | 85 | 38 | 90 | 40 | 92 | 35 | 93 |
| Tensile breaking elongation | % | — | | 267 | 53 | 206 | 54 | 230 | 55 | 220 | 50 | 214 | 53 |
| Tensile breaking strength | MPa | — | | 35 | — | 43 | — | 35 | — | 41 | — | 36 | — |
| at 5° C. | | | | | | | | | | | | | |
| Tensile breaking elongation | % | — | | 108 | — | 182 | — | 123 | — | 62 | — | 154 | — |
| at 5° C. | | | | | | | | | | | | | |
| Elongation breakage count | Samples/N | — | | 2/4 | — | 0/4 | — | 2/4 | — | 3/4 | — | 0/4 | — |
| at 5° C. | samples | | | | | | | | | | | | |
| Impact puncture strength | J | — | | 0.34 | | 0.29 | | 0.30 | | 0.19 | | 0.27 | |
| Young's modulus | GPa | — | | 1.6 | 2.0 | 1.6 | 2.1 | 1.6 | 2.0 | 1.6 | 2.1 | 1.6 | 2.0 |
| Compressive strength | N | — | | 0.78 | — | 0.88 | — | 0.89 | — | 0.88 | — | 0.87 | — |
| Shrinkage rate | % | 70° C. | 10 seconds | −1 | 9 | −1 | 8 | −1 | 7 | −1 | 5 | −1 | 6 |
| | | 80° C. | 10 seconds | −1 | 36 | 0 | 36 | −1 | 35 | −1 | 31 | −1 | 33 |
| | | 90° C. | 10 seconds | 7 | 63 | 9 | 62 | 7 | 62 | 5 | 60 | 5 | 61 |
| | | 98° C. | 10 seconds | 16 | 75 | 15 | 74 | 16 | 73 | 15 | 73 | 16 | 73 |
| Natural shrinkage | % | 30° C. | 1 week | 0.0 | 0.5 | 0.0 | 0.5 | 0.0 | 0.5 | 0.0 | 0.5 | 0.0 | 0.4 |
| rate | | 40° C. | 1 week | −0.3 | 2.1 | −0.2 | 1.9 | −0.1 | 1.8 | −0.1 | 1.7 | −0.2 | 1.8 |

| | | | | | | | |
|---|---|---|---|---|---|---|---|
| Haze | % | — | 4.6 | 5.6 | 5.7 | 5.7 | 5.6 |
| Mirror-surface gloss | % | — | 148 | 140 | 138 | 137 | 128 |

| | | | | Ex. 6 | | Ex. 7 | | Ex. 8 | | Ex. 9 | |
|---|---|---|---|---|---|---|---|---|---|---|---|
| Measurement item | Units | Measurement condition | | MD | TD | MD | TD | MD | TD | MD | TD |
| Tensile breaking strength | MPa | — | | 42 | 87 | 39 | 101 | 38 | 102 | 39 | 99 |
| Tensile breaking elongation | % | — | | 200 | 49 | 216 | 54 | 208 | 53 | 220 | 53 |
| Tensile breaking strength | MPa | — | | 43 | — | 39 | — | 40 | — | 39 | — |
| at 5° C. | | | | | | | | | | | |
| Tensile breaking elongation | % | — | | 63 | — | 123 | — | 115 | — | 110 | — |
| at 5° C. | | | | | | | | | | | |
| Elongation breakage count | Samples/N | — | | 3/4 | — | 2/4 | — | 1/4 | — | 2/4 | — |
| at 5° C. | samples | | | | | | | | | | |
| Impact puncture strength | J | — | | 0.19 | | 0.26 | | 0.26 | | 0.26 | |
| Young's modulus | GPa | — | | 1.6 | 2.2 | 1.5 | 2.0 | 1.6 | 2.2 | 1.6 | 2.4 |
| Compressive strength | N | — | | 0.89 | — | 0.88 | — | 0.88 | — | 0.89 | — |
| Shrinkage rate | % | 70° C. | 10 seconds | −1 | 4 | −1 | 5 | −1 | 5 | 0 | 5 |
| | | 80° C. | 10 seconds | −1 | 29 | −1 | 31 | 0 | 30 | −1 | 31 |
| | | 90° C. | 10 seconds | 4 | 59 | 3 | 61 | 3 | 60 | 3 | 61 |
| | | 98° C. | 10 seconds | 15 | 72 | 18 | 73 | 18 | 73 | 17 | 73 |
| Natural shrinkage | % | 30° C. | 1 week | 0.0 | 0.4 | 0.0 | 0.4 | 0.0 | 0.4 | 0.0 | 0.4 |
| rate | | 40° C. | 1 week | −0.1 | 1.8 | −0.3 | 1.8 | −0.3 | 1.7 | −0.2 | 1.7 |

| | | | | | | |
|---|---|---|---|---|---|---|
| Haze | % | — | 5.6 | 5.6 | 8.0 | 9.5 |
| Mirror-surface gloss | % | — | 127 | 114 | 110 | 100 |

TABLE 4

| | | | | Comp. Ex. 1 | | Comp. Ex. 2 | | Comp. Ex. 3 | | Comp. Ex. 4 | |
|---|---|---|---|---|---|---|---|---|---|---|---|
| Measurement item | Units | Measurement condition | | MD | TD | MD | TD | MI | TD | MD | TD |
| Tensile breaking strength | MPa | — | | 41 | 99 | 34 | 104 | 42 | 86 | 42 | 86 |
| Tensile breaking elongation | % | — | | 227 | 41 | 170 | 38 | 250 | 59 | 250 | 59 |
| Tensile breaking strength at 5° C. | MPa | — | | 28 | — | 39 | — | 34 | — | 34 | — |
| Tensile breaking elongation at | % | — | | 41 | — | 54 | — | 94 | — | 62 | — |
| 5° C. | | | | | | | | | | | |
| Elongation breakage count at | Samples/N | — | | 4/4 | — | 4/5 | — | 1/4 | — | 2/4 | — |
| 5° C. | samples | | | | | | | | | | |
| Impact puncture strength | J | — | | 0.19 | | 0.16 | | 0.29 | | 0.16 | |
| Young's modulus | GPa | — | | 1.6 | 2.2 | 1.8 | 2.4 | 1.6 | 1.9 | 1.6 | 2.0 |
| Compressive strength | N | — | | 0.89 | — | 0.98 | — | 0.85 | — | 0.85 | — |
| Shrinkage rate | % | 70° C. | 10 seconds | −1 | 3 | 0 | 1 | −1 | 11 | −1 | 8 |
| | | 80° C. | 10 seconds | −1 | 21 | −1 | 12 | −2 | 38 | −2 | 31 |
| | | 90° C. | 10 seconds | 3 | 54 | 1 | 38 | 5 | 63 | 5 | 60 |
| | | 98° C. | 10 seconds | 16 | 72 | 10 | 68 | 12 | 74 | 12 | 73 |
| Natural shrinkage rate | % | 30° C. | 1 week | 0.0 | 0.5 | 0.0 | 0.2 | 0.0 | 0.6 | 0.0 | 0.6 |
| | | 40° C. | 1 week | −0.1 | 1.8 | −0.1 | 1.5 | −0.2 | 2.2 | −0.2 | 2.1 |

| | | | | | | |
|---|---|---|---|---|---|---|
| Haze | % | Not shrunk | 18.8 | 20.0 | 4.1 | 4.1 |

| | | | | | | |
|---|---|---|---|---|---|---|
| Mirror-surface gloss | % | — | 83 | 78 | 155 | 155 |

As shown in Tables 3 and 4, Examples 1 to 9 had better overall results for “tensile breaking strength at 5° C.” and “tensile breaking elongation at 5° C.” than Comparative Examples 1 to 4. That is, Examples 1 to 9 exhibited high mechanical properties in a low-temperature environment. In addition, Examples 1 to 9 showed a tendency to be better than at least Comparative Examples 1 and 2 with respect to “shrinkage rate”, “haze”, and “mirror-surface gloss”. As described above, Examples 4 and 6 had better overall results than Comparative Example 4 for “tensile breaking strength at 5° C.” and “tensile breaking elongation at 5° C.”. These results show that the overall results for “tensile breaking strength at 5° C.” and “tensile breaking elongation at 5° C.” are better when the intermediate layer contains both the first and second HIPSs compared to when the intermediate layer contains only the second HIPS.

In addition, when Examples 4 and 6, in which the intermediate layer does not contain SBS, are compared with Comparative Example 4, Examples 4 and 6 showed better results (smaller natural shrinkage rate) in terms of the natural shrinkage rate in the TD than Comparative Example 4. In addition, when comparing Examples 1 to 3, 5, and 7 to 9, in which the intermediate layer contains the first HIPS, with Comparative Example 3, in which the intermediate layer does not contain the first HIPS, the results for Examples 1 to 3, 5, and 7 to 9 were better than that for Comparative Example 3 in terms of the natural shrinkage rate in the TD. That is, it was found that the natural shrinkage rate was better when the intermediate layer contained the first HIPS compared to when the intermediate layer did not contain the first HIPS.

### LIST OF REFERENCE NUMERALS

10 Heat-shrinkable film
20 Manufacturing apparatus
100 First surface layer
110 Second surface layer
120 Intermediate layer
200 T-die
201 T-die body
210, 220 Casting roll
230 Take-up roll
240, 250, 260 Raw material input portion

1. A heat-shrinkable film comprising:
a first surface layer;
a second surface layer; and
an intermediate layer formed between the first surface layer and the second surface layer,
wherein the intermediate layer contains a first high-impact polystyrene and a second high-impact polystyrene,
the first high-impact polystyrene contains a general-purpose polystyrene and a first rubber component,
the second impact polystyrene contains a styrene-butyl acrylate copolymer and a second rubber component,
the first rubber component has a particle size that is larger than the particle size of the second rubber component, and
a blending ratio of the first high-impact polystyrene in the intermediate layer is greater than 0 wt % and less than 45.7 wt %.

2. The heat-shrinkable film according to claim 1,
wherein the first rubber component has a particle size of 1 μm or more and 3 μm or less, and
the second rubber component has a particle size of less than 1 μm.

3. The heat-shrinkable film according to claim 1,
wherein a blending ratio of the first high-impact polystyrene in the intermediate layer is 4.6 wt % or more and 36.6 wt % or less.

4. The heat-shrinkable film according to claim 1,
wherein the intermediate layer further contains a styrene-butadiene copolymer.

5. The heat-shrinkable film according to claim 1,
wherein a tensile breaking strength in an MD (Machine Direction) measured in conformity with JIS K-6732 in a 5° C. environment is 35 MPa or more and 43 MPa or less.
